(19) United States
(12) Patent Application Publication
(10) Pub. No.: US 2003/0222989 A1
(43) Pub. Date: Dec. 4, 2003

(54) Image pickup apparatus and image pickup display system

(76) Inventor: Hidetoshi Wada, Tochigi (JP)

Correspondence Address: MORGAN & FINNEGAN, L.L.P., 345 PARK AVENUE, NEW YORK, NY, 10154, US

(21) Appl. No.: 10/452,021

(22) Filed: May 30, 2003

(30) Foreign Application Priority Data
Jun. 4, 2002 (JP) 2002-163471

(51) Int. Cl. H04N 5/228

(52) U.S. Cl. 348/208.4

(57) ABSTRACT

The present invention discloses an image pickup apparatus which achieves easy image composition adjustments and image-taking angle changes. The image pickup apparatus of the invention comprises a signal processing circuit which generates image data from the image pickup device, a movement judging circuit which judges the existence of movement in an object image based on the pixel signals, and a control circuit which controls the drive of the image pickup device. The control circuit drives the image pickup device in a first mode in which pixel signals are outputted from all pixels of the image pickup device when the movement judging circuit judges that the object image has no movement, and drives the image pickup device in a second mode in which pixel signals are outputted from a part of all pixels of the image pickup device when it is judged that the object image has movement.

### BACKGROUND OF THE INVENTION

1. Field of the Invention

The present invention relates to an image pickup apparatus which uses an image pickup device composed of a CCD (charge-coupled device), and is, particularly, suitable for a document camera.

2. Description of Related Art

An overhead projector (hereinafter, referred to as OHP) has been used as a presentation tool. This OHP projects light onto a written transparent film or copied document, and projects the transmitted or reflected light onto a screen through an enlarging optical system.

Recently, an image pickup apparatus called a document camera has also been used so that image signals outputted from a video camera part when a document placed on a document base is shot by a video camera are projected onto a screen by a projector or displayed on a monitor of a television or a personal computer.

Conventionally, a camera part of a combination camera-recorder system has been normally appropriated for the video camera part of the document camera. However, the pixel number to be outputted is only 720(H)×480(V) even in the case of a DV standard video camera, so that it is not sufficient in terms of resolution in some cases where a document with fine print, etc., is displayed.

Therefore, document cameras using video cameras that output image signals with a high resolution such as 1024(H)×768(V) or 1600(H)×1200(V) have been developed.

Herein, when a single-plate CCD is used as an image pickup device to output image signals with a high resolution of 1600(H)×1200(V), the CCD is required to have about 2 million pixels. However, the drive clock of the CCD is limited to a certain extent, and when all of the 2 million pixels of the CCD are readout, signals are outputted at about 5 frames/second although signals are outputted at 30 frames/second (actually 60 field/second) in a standard television format (NTSC).

As mentioned above, since image signals outputted from a document camera with a video camera part of such a 2-million pixel class are low in frame rate and inferior in quality as a moving image, it becomes difficult for a user to position the document on the document base (image composition adjustments) while observing the image thereof.

As means for picking-up a moving image that is commonly used as high-quality still images, Japanese Laid-Open No. 2000-299810 discloses a method in which, in an image pickup apparatus to output images in the standard television format, by using an image pickup device having pixels more than those required for displaying images in the standard television format, interlaced reading and vertical high-rate transfer by a CCD are carried out to shoot a moving image, and all-pixel reading or pixel signal reading by charge control frame transfer drive without adding pixels vertically are carried out to shoot a still image with high quality.

The abovementioned means is provided for picking-up a moving image in the standard television format in principle, and, a CCD which can carry out interlaced reading to pick-up a moving image in the standard television format and also all-pixel nonadditive reading to pick-up a still image with high quality is used.

However, the reading rate of the CCD has limitations, and the effective pixel number of the CCD for picking-up signals in the standard television format is also necessarily limited, and therefore, it is difficult to apply the abovementioned means to a high pixel number CCD of a 3 million or higher pixel-number class to be used for, for example, a digital still camera, etc.

As a method for high-rate reading image signals of a CCD image pickup device, a method for line thinning-out while maintaining a color sequence during all-pixel reading has been proposed in Japanese Laid-Open No. 1997-298755.

For example, when an image pickup device drive circuit drives a CCD so that two lines are readout and another two lines are thinned-out so as not to be readout, half of the lines of the CCD are thinned-out as a result, and pixel data can be readout in half the time although the vertical resolution lowers to half.

FIG. 7 shows the arrangement of CCD pixels, wherein the numerals on the left of the figure indicate line numbers. Herein, lines are normally sequentially readout in order of the first, second, and third line. However, the lines are thinned-out while maintaining the same color sequence as in all-pixel reading so that the fifth and sixth lines are readout after the first and second lines are readout, and then the nine and tenth lines are readout, whereby half of the lines of the CCD are thinned-out, and as a result, the frame rate doubles.

FIG. 8 shows image signals to be outputted in the case of all-line reading and image signals to be outputted in the case of thinning-out reading. Herein, image signals to be outputted when the lines to be readout are reduced to one fourth are shown, and it is proved that the frame rate quadruples when the lines are thinned-out to one fourth in comparison with the case of all-line reading.

### SUMMARY OF THE INVENTION

An object of the invention is to provide an image pickup apparatus which has an image pickup device such as a CCD or CMOS, etc., and achieves easy image composition adjustments and image-taking angle changes.

An image pickup apparatus of the invention comprises an image pickup device composed of a charge-coupled device or a complementary metal-oxide semiconductor which photoelectrically converts an object image formed by an image-taking optical system and outputs pixel signals, a signal processing circuit which generates image data by processing the pixel signals outputted from the image pickup device, a movement judging circuit which judges the presence or absence of movement in the object image on the image pickup device, and a control circuit which controls the drive of the image pickup device. The control circuit drives the image pickup device in a first mode in which pixel signals are outputted from all pixels of the image pickup device when the movement judging circuit judges that the object image on the image pickup device has no movement, and drives the image pickup device in a second mode in which pixel signals are outputted from a part of all pixels of the image pickup device when it is judged that the object image has movement.

A detailed configuration of the image pickup apparatus and image pickup display system of the invention, the above and other objects and features of the invention will be apparent from the embodiment, described below.

### BRIEF DESCRIPTION OF THE DRAWINGS

FIG. 1 is a perspective view showing the structure of a document camera of an embodiment of the invention.

FIG. 2 is a block diagram showing the structure of an image pickup system of the document camera.

FIG. 3 is a block diagram showing the structure of a movement judging circuit of the image pickup system.

FIG. 4 is a diagram showing binarized pixel signals to be outputted from a binarization circuit and a memory during all-line reading and line thinning-out reading in the image pickup system.

FIG. 5 is a block diagram showing the structure of a line interpolation circuit of the image pickup system.

FIG. 6 is a flowchart showing operation of a CCD drive control circuit of the image pickup system.

FIG. 7 is a diagram showing the arrangement of the lines of the CCD.

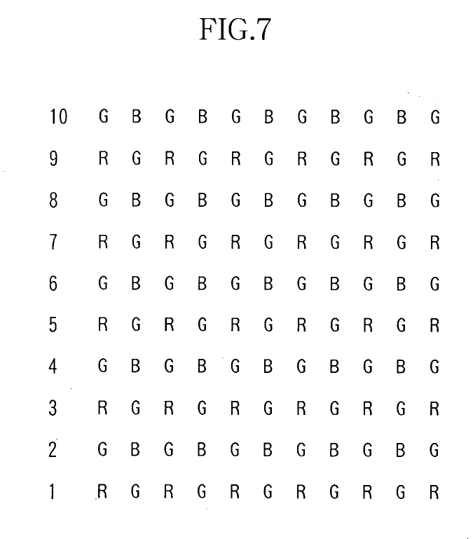

FIG. 8 is a diagram showing pixel signals to be outputted during all-line reading and line thinning-out reading.

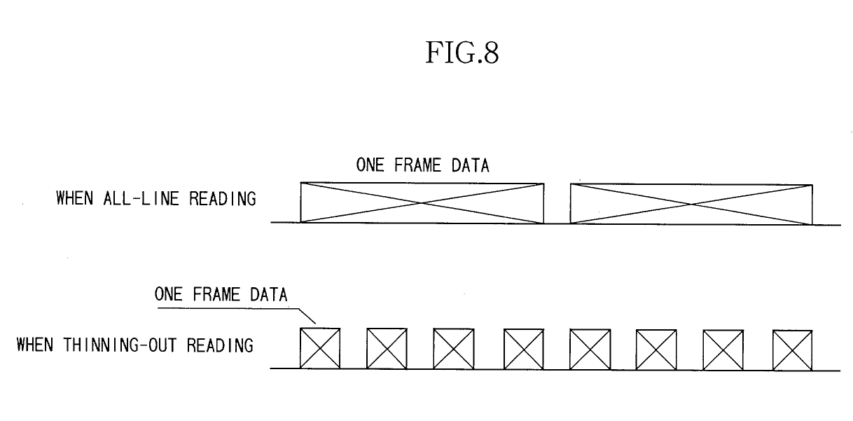

### DETAILED DESCRIPTION OF THE PREFERRED EMBODIMENTS

Hereinafter, preferred embodiment of the invention will be described in detail with reference to the drawings.

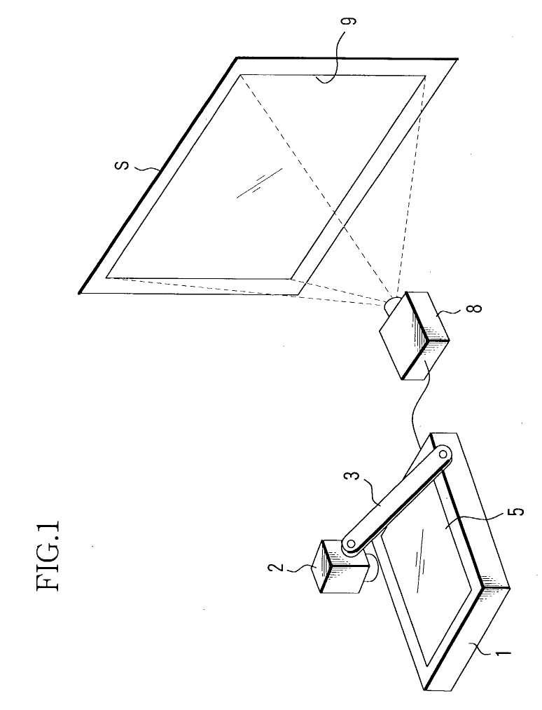

FIG. 1 shows the structure of a document camera (image pickup apparatus) of an embodiment of the invention. In FIG. 1, a document base 1 is for mounting a document 5. A camera part 2 houses an image-taking optical system described later and a CCD, etc. The camera part 2 is supported above the document base 1 by an arm 3.

To this document camera, an image display apparatus 8 such as a projector, television, or personal computer is electrically connected, and image signals outputted from the document camera are displayed by the image display apparatus 8. FIG. 1 shows a condition where an image 9 of the document 5 is projected and displayed on a screen S by a projector.

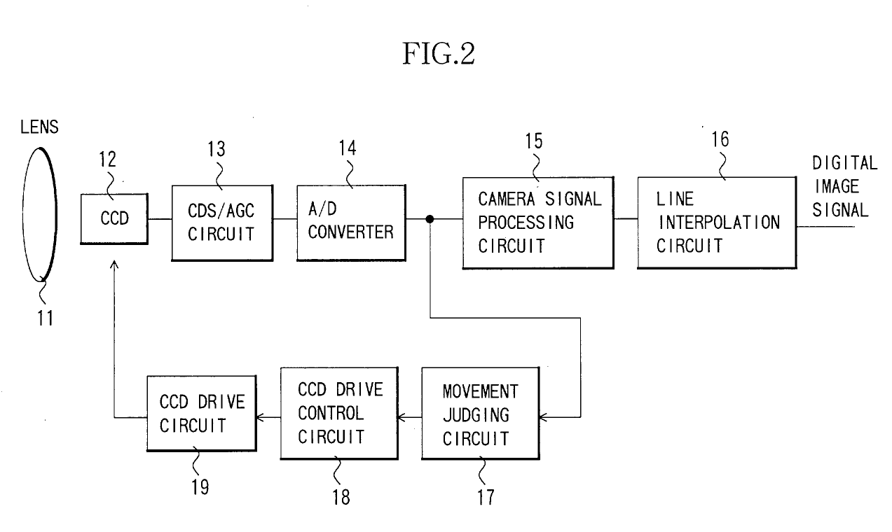

FIG. 2 shows the structure of the image pickup system of the document camera of this embodiment. The image of the document 5 that has been made incident from an image pickup optical system (lens) 11 and formed is converted into pixel signals by a CCD (image pickup device) 12. Pixel signals outputted from the CCD 12 are subjected to noise reduction processing by means of correlative double sampling at a CDS/AGC circuit 13 and gain-adjusted. Analog pixel signals are digitized by an A/D converter 14 and inputted into a camera signal processing circuit 15.

Digital pixel signals outputted from the A/D converter 14 are also inputted into a movement judging circuit 17.

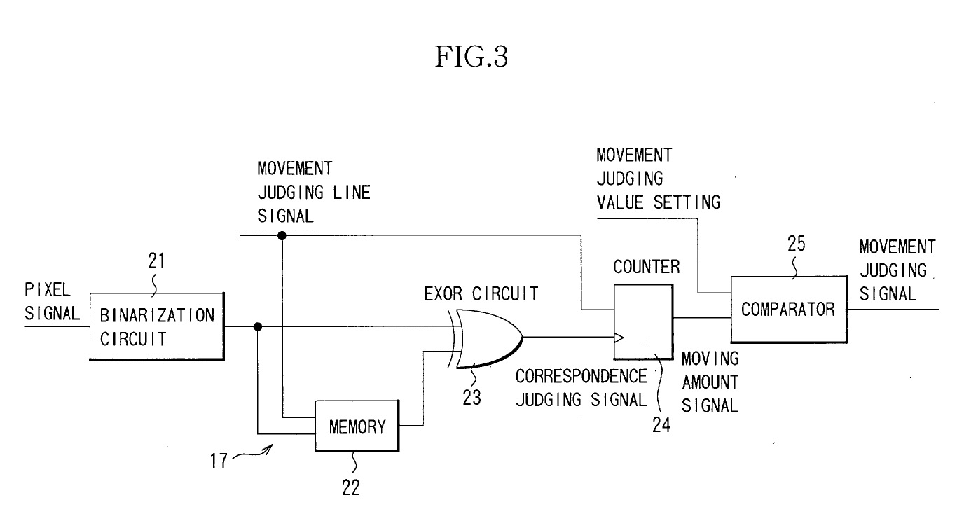

FIG. 3 shows the structure of the movement judging circuit 17. Herein, the digital pixel signals inputted from the A/D converter 14 are binarized by a binarization circuit 21.

As binarization processing of digital pixel signals, a comparator (not shown) may be used to judge whether the level of the inputted digital pixel signal is higher or lower than a certain level. Furthermore, another binarization processing for digital pixel signals is also possible in that a filter (not shown) is used to limit the band of the digital pixel signals, and binarization is carried out based on the polarities (positive/negative) of signals the band of which has been limited. Herein, when a band pass filter is used as a filter, the low-frequency band is limited, and accordingly, the signals are prevented from being influenced by the brightness of the image-taking environment. Furthermore, by limiting the high-frequency band, affects of noise included in the high-frequency band can be reduced. These are suitable for binarization in this embodiment.

Binarized pixel signals are inputted into one of the terminals of an EXOR circuit 23 and are inputted into the other terminal of the EXOR circuit 23 via a memory 22.

The memory 22 stores binarized pixel signals inputted from the binarization circuit 21 based on movement judging line signals inputted from the CCD drive control circuit 18 shown in FIG. 2.

The movement judging line signals inputted from the CCD drive control circuit 18 are outputted as signals for distinguishing lines that are not to be thinned-out when the CCD drive circuit 19 controls to carry out thinning-out as described later. Furthermore, when thinning-out driving is not carried out, movement judging line signals are also outputted as signals for distinguishing lines that are not to be thinned-out during thinning-out in the same manner as during thinning-out.

Therefore, the CCD drive control circuit 18 outputs movement judging line signals for each line when the CCD 12 is not driven to carry out thinning-out, and outputs movement judging line signals once every several lines in response to the thinning-out ratio when thinning-out driving is carried out.

The memory 22 stores only binarized pixel signals outputted from lines that are not thinned-out based on movement judging line signals inputted from the CCD drive control circuit 18 in both cases where the CCD 12 is driven to carry out thinning-out and is not driven.

Then, the binarized pixel signals stored in the memory 22 (binarized pixel signals from the previous frame) are outputted at the same timing as outputting of the binarized pixel signals of the current frame from the binarization circuit 21 so that they assume the same positions on the CCD 12.

Namely, in both cases where thinning-out driving is carried out and where thinning-out driving is not carried out, from the memory 22, the binarized pixel signals derived from lines on the CCD 12 are outputted at the same timings as one-frame-later binarized pixel signals derived from the lines at the same positions on the CCD 12.

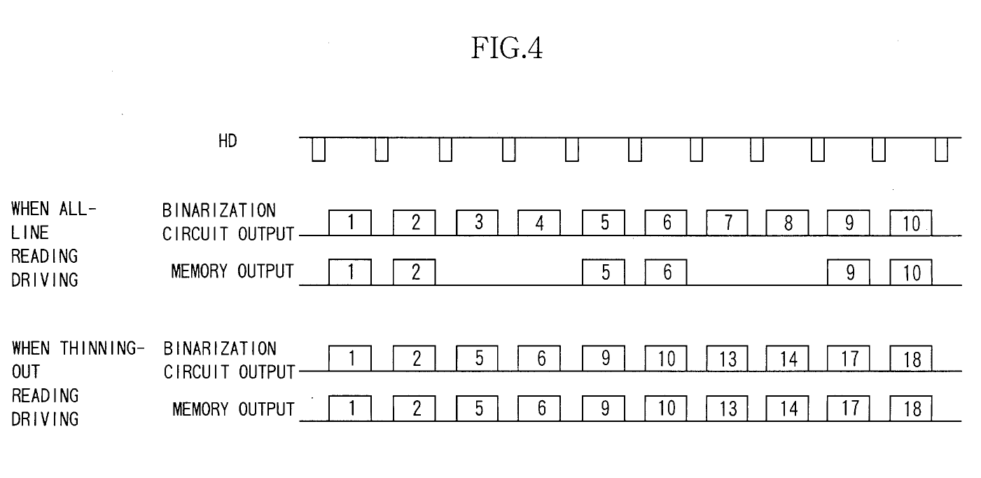

FIG. 4 is a diagram showing output signals from the binarization circuit 21 and output signals from the memory 22 in cases of all-line reading driving and thinning-out reading. The reference symbol HD indicates horizontal sync signals. Herein, in the case of all-line reading driving, output signals from the binarization circuit 21 are outputted in order from the first line, and from the memory 22, signals are outputted from only lines that are not to be thinned-out.

In the case of thinning-out reading, signals are outputted from the CCD 12 after the lines are thinned-out, so that after output signals from the binarization circuit 21 are outputted from the first and second lines, signals are outputted from the fifth and sixth lines, and signals are also outputted from the memory 22 in the same manner at the same timings as outputting from the binarization circuit 21 so that outputting from the fifth and sixth lines follows outputting from the first and second lines.

By thus controlling the memory 22, even in either case where the all-line reading driving is switched to thinning-out reading driving or switching in reverse is carried out, only binarized pixel signals of the same lines as the lines from which the CCD 12 outputs signals during thinning-out driving are stored in and outputted from the memory 22. That is, lines from which pixel signals are outputted for movement judgement described later are the same in both modes. Therefore, at the same timings as outputting of current binarized pixel signals from the binarization circuit 21, binarized pixel signals from the lines of the previous (past) frame at the same positions on the CCD 12 are outputted from the memory 22.

As mentioned above, on the basis of the current binarized pixel signals outputted from the binarization circuit 21 and the binarized pixel signals of the previous frame outputted from the memory 22, the EXOR circuit 23 shown in FIG. 3 operates an XOR.

In the EXOR circuit 23, when the inputted binarized pixel signals are different from each other such as “0” and “1” or “1 and “0”, “1” is outputted. Furthermore, when the inputted binarized pixel signals match each other such as “0” and “0” or “1” and “1”, “0” is outputted.

In other words, the EXOR circuit 23 compares the current binarized pixel signal and the binarized pixel signal of the previous frame, and when these match each other, “0” is outputted as a correspondence judging signal. Thereby, based on the respective pixel signals, it can be judged that the image picked up as the pixel signals has no movement. Furthermore, if the pixel signals do not match each other, “1” is outputted as a correspondence judging signal. Thereby, based on the respective pixel signals, it can be judged that the image picked up as the pixel signals has movement.

Then, the correspondence judging signals indicating the results of judgement of movement of each pixel outputted from the EXOR circuit 23 are inputted into a counter 24.

The counter 24 counts correspondence judging signals outputted from the EXOR circuit 23. Counting is carried out for a period corresponding to one frame, and the counting result is outputted as a moving amount signal. Namely, pixels that have been judged as having movement by comparing the image of the previous frame and the image of the current frame are counted.

Herein, the counter 24 does not count correspondence judging signals of all pixel signals in the period corresponding to one frame, but counts only correspondence judging signals regarding pixel signals of lines to be also readout when the CCD drive circuit 19 drives the CCD 12 so as to carry out thinning-out driving in response to movement judging line signals outputted from the CCD drive control circuit 18 shown in FIG. 2.

Then, the counter 24 outputs a moving amount signal which is a result of counting correspondence judging signals of one frame regarding the pixel signals of the lines to be also readout when the CCD 12 is driven to carry out thinning-out driving.

By thus controlling the counter 24, even when the all-line reading driving is switched to thinning-out reading driving, the EXOR circuit 23 can count only correspondence judging signals which are results of carrying out a logic operation operated between a current pixel signal and a previous frame pixel signal from the same line.

The moving amount signal outputted from the counter 24 is inputted into a comparator 25. At the comparator 25, the moving amount signal is inputted, and a movement judging value is set.

Herein, the movement judging value set may be optional, or may be set in consideration of a noise level of the picked-up image. For example, an image picked up at a bright site is low in noise level and errors in movement judgments due to noise are reduced, so that the movement judging value is set to be low. On the other hand, an image picked up at a dark site is high in noise level and errors in movement judgements due to noise increase, so that the movement judging value is set to be high. Concretely, the camera signal processing circuit 15 takes in a luminance signal generated as described later, and when the brightness of the image indicated by the luminance signal is higher than a predetermined level, the movement judging value is set to be high, and when it is lower than the predetermined level, the movement judging value is set to be low.

Thereby, a movement judging value suitable for the picked up image can be set.

Then, the comparator 25 compares the moving amount signal inputted from the counter 24 and the set movement judging value, and when the moving amount signal is lower than the movement judging value, it is judged that no movement exists in the corresponding frame. On the other hand, when the moving amount signal is higher than the movement judging value, it is judged that there is movement in the frame. The comparator 25 outputs the result of judgement as a movement judging signal.

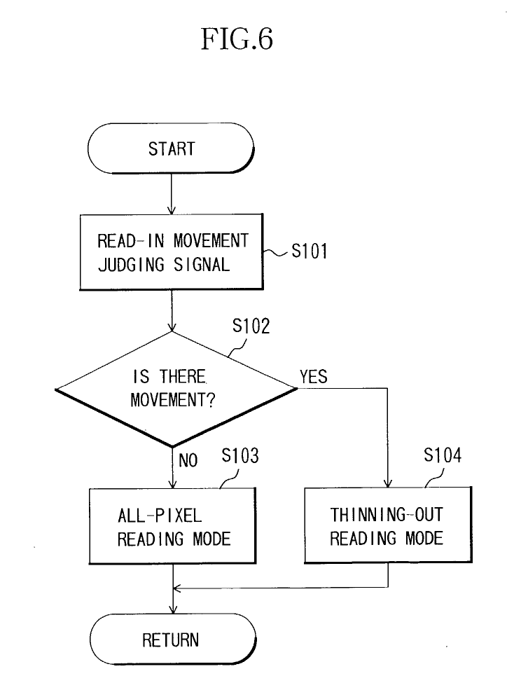

Returning to FIG. 2, the movement judging signal outputted from the movement judging circuit 17 (comparator 25) is inputted into the CCD drive control circuit 18. The flowchart of FIG. 6 shows operation of the CCD drive control circuit 18.

The CCD drive control circuit 18 reads-in the inputted movement judging signal (Step (abbreviated to S in the figure) 101). Then, in a case where the read-in movement judging signal indicates that there is no movement in the picked up image (S102), a mode in which the CCD drive circuit 19 is controlled to readout pixel signals from all vertical lines of the CCD 12, that is, an all-pixel reading mode is set (S103). Thereby, the CCD 12 is controlled so that an image with a high vertical resolution can be readout although the frame rate thereof is low.

Furthermore, when the read-in movement judging signal indicates that there is movement in the picked up image (S102), the CCD drive control circuit 18 sets a thinning-out reading mode in which the CCD drive circuit 19 is controlled so that pixel signals are outputted from a part of all vertical lines of the CCD 12, that is, only n lines every m lines (m and n are integers, m>n) (in other words, other lines are thinned-out) (S104). Thereby, the CCD 12 is controlled so that the frame rate becomes higher although the vertical resolution becomes lower than in the all-pixel reading mode.

On the other hand, the pixel signals digitized by the A/D converter 14 are inputted into not only the movement judging circuit 17 but also the camera signal processing circuit 15.

The camera signal processing circuit 15 comprises a matrix circuit, a gamma correction circuit, and a white balance circuit, etc., and generates luminance signals and color signals from the digital pixel signals inputted from the A/D converter 14 and outputs them.

The luminance signals and color signals outputted from the camera signal processing circuit 15 are generated from the pixel signals of all lines of a frame when the CCD 12 is driven in the all-pixel reading mode (when the movement judging circuit 18 judges that there is no movement in the image), however, when the CCD 12 is driven in the thinning-out reading mode (when the movement judging circuit 17 judges that there is movement in the image), the luminance signals and color signals are generated from only the reduced number of pixel signals according to the thinned-out lines.

For example, when the lines are thinned-out to half in the thinning-out reading mode, luminance signals and color signals that are only half those outputted when all lines are readout, are outputted from the camera signal processing circuit 15.

Therefore, interpolated luminance signals and interpolated color signals, which are obtained by interpolating the luminance signals and color signals of the thinned-out lines are generated in an line interpolation circuit 16 so that luminance signals and color signals of the same number of lines as in the case where all lines are readout in the all-pixel reading mode are also outputted in the thinning-out reading mode.

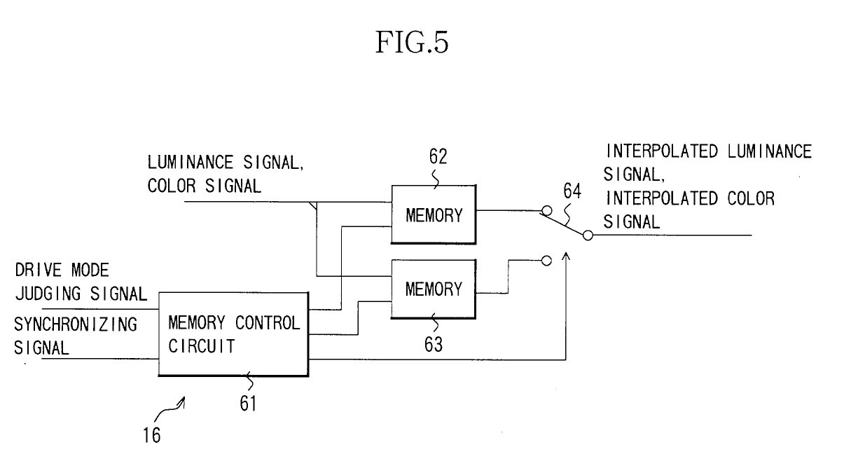

FIG. 5 shows the structure of the line interpolation circuit 16. Luminance signals and color signals inputted from the camera signal processing circuit 15 are stored in a memory 62 and a memory 63.

Herein, a memory control circuit 61 drives the memory 62 and the memory 63 on the basis of a drive mode judging signal inputted from the CCD drive control circuit 18 for distinction between the all-line reading mode and the thinning-out reading mode and a HD/VD synchronizing signal.

When the drive mode judging signal inputted from the CCD drive control circuit 18 indicates the all-line reading mode, all luminance signals and color signals are outputted after being temporarily stored in the memory 62, or through outputted without temporary storing. In this case, selector 64 always selects and then outputs luminance signals and color signals outputted from the memory 62.

When the drive mode judging signal inputted from the CCD drive control circuit 18 indicates the thinning-out reading mode, the memory 62 and the memory 63 alternately store luminance signals and color signals of one frame that has been subjected to thinning-out. For example, in the case of thinning-out to half, by switching with a selector 64, luminance signals and color signals of the same line are readout alternately two times from the memory 62 and the memory 63. The selector 64 is controlled by the memory control circuit 61 so as to select an output of either one memory from which the luminance signal and color signal are being readout.

Then, the output signals (luminance signals and color signals) from the line interpolation circuit 16 are outputted to the image display apparatus 8 as image signals.

As mentioned above, according to this embodiment, during document alignment (image composition adjustments) while relative movements of the document and the CCD are detected from picked-up image signals or during adjustments of angle of view of the camera part, document alignment and adjustments of angle of view of the camera part can be made easier by setting the thinning-out reading mode and increasing the frame rate although the vertical resolution lowers. Furthermore, when no relative movements of the document and the CCD are detected from the picked-up image signals, the all-pixel reading mode is set, whereby a high-quality image with a high vertical resolution can be outputted although the frame rate thereof is low.

Thereby, for example, in a document camera having a high-pixel number CCD with several millions or more of pixels, an image pickup apparatus which can achieve easy document alignment and adjustments of angle of view of the camera part, and furthermore, can pick up an image with high quality is realized. As a matter of course, the invention is applicable even to a case where an image pickup device the pixel number of which is not as high as mentioned above is used.

In the abovementioned embodiment, a structure using a CCD as an example of the image pickup device is described, however, it may be used a CMOS device. In the case of using a CMOS device, lines to be readout from the image pickup device based on the results of movement detection are, as in the abovementioned embodiment using a CCD, realized by thinning-out in line units as shown in FIG. 4.

Furthermore, in the embodiment using a CCD, when movement is detected in a picked-up image, thinning-out of lines to be readout is carried out in line units to increase the frame rate. Herein, in the case of a CMOS device, since reading-out control of optional pixels in pixel units is possible, for example, not only line thinning-out but also thinning-out of optional pixels in horizontal lines become possible. Therefore, in the structure using a CMOS, in place of the line interpolation circuit shown in FIG. 5, a pixel interpolation circuit (not shown) is used. Thus, in the structure using a CMOS, data to be thinned-out increases more than in the structure using a CCD, whereby the frame rate can be increased. Thus, in an embodiment using a CMOS, even when an image pickup device having a higher number of pixels is used, document positioning and angle of view adjustments can be easily carried out.

Furthermore, in the abovementioned embodiment, a document camera is described, however, the present invention is applicable to other image pickup apparatuses, for example, digital still cameras and video cameras.

While preferred embodiment has been described, it is to be understood that modification and variation of the present invention may be made without departing from scope of the following claims.

What is claimed is:

1. An image pickup apparatus comprising:
an image-taking optical system,
an image pickup device which photoelectrically converts an object image formed by the image-taking optical system and outputs pixel signals,
a signal processing circuit which generates image data by processing the pixel signals outputted from the image pickup device,
a movement judging circuit which judges the presence or absence of movement in the object image on the image pickup device based on the pixel signals from the image pickup device, and
a control circuit which controls the drive of the image pickup device, wherein
the control circuit drives the image pickup device in a first mode in which pixel signals are outputted from all lines of the image pickup device when the movement judging circuit judges that the object image on the image pickup device has no movement, and drives the image pickup device in a second mode in which pixel signals are outputted from a part of all lines of the image pickup device when the movement judging circuit judges that the object image has movement.

2. The image pickup apparatus according to claim 1, wherein
the control circuit drives the image pickup device in the first mode when the movement judging circuit judges that the object image has no movement, and drives the image pickup device in the second mode in which pixel signals are outputted from n lines every m lines (m and n are integers, and m>n) in all lines of the image pickup device when the movement judging circuit judges that the object image has movement.

3. The image pickup apparatus according to claim 1, wherein
the movement judging circuit detects movement of the object image on the image pickup device based on pixel signals from lines of the image pickup device, which output the pixel signals in the second mode.

4. The image pickup apparatus according to claim 1, wherein
the movement judging circuit judges that the object image has movement when information showing a moving amount of the object image obtained on the basis of the pixel signals is larger than a predetermined value, and judges that the object image has no movement when the information is smaller than the predetermined value.

5. The image pickup apparatus according to claim 4, wherein
the predetermined value set in the movement judging circuit is changed according to information showing the brightness of the object image obtained from the pixel signals that are outputted from the image pickup device.

6. An image pickup display system comprising:
an image pickup apparatus according to claim 1, and
an image display apparatus which displays image signals outputted from the image pickup apparatus.

7. An image pickup apparatus comprising:
an image-taking optical system,
an image pickup device which photoelectrically converts an object image formed by the image-taking optical system and outputs pixel signals,
a signal processing circuit which generates image data by processing the pixel signals outputted from the image pickup device,
a movement judging circuit which judges the presence or absence of movement in the object image on the image pickup device based on the pixel signals from the image pickup device, and
a control circuit which controls the drive of the image pickup device, wherein
when the movement judging circuit judges that the object image on the image pickup device has no movement, the control circuit drives the image pickup device in a first mode in which pixel signals are outputted from all pixels of the image pickup device, and drives the image pickup device in a second mode in which pixel signals are outputted from a part of all pixels of the image pickup device when the movement judging circuit judges that the object image has movement.

8. The image pickup apparatus according to claim 7, wherein
the movement judging circuit detects movement of the object image on the image pickup device based on the pixel signals from pixels of the image pickup device, which output the pixel signals in the second mode.

9. The image pickup apparatus according to claim 7, wherein
the movement judging circuit judges that the object image has movement when information showing the moving amount of the object image obtained on the basis of the pixel signals is larger than a predetermined value, and judges that the object image has no movement when the moving amount is smaller than the predetermined value.

10. The image pickup apparatus according to claim 9, wherein
the predetermined value in the movement judging circuit is changed according to information showing the brightness of the object image obtained from the pixel signals that are outputted from the image pickup device.

11. An image pickup display system comprising:
an image pickup apparatus according to claim 7, and
an image display apparatus which shows image signals outputted from the image pickup apparatus.
